(19) United States
(12) Patent Application Publication
(10) Pub. No.: US 2011/0321082 A1
(43) Pub. Date: Dec. 29, 2011

(54) User-Defined Modification of Video Content

(75) Inventor: Srilal Weerasinghe, Austin, TX (US)

(73) Assignee: AT&T INTELLECTUAL PROPERTY I, L.P., Reno, NV (US)

(21) Appl. No.: 12/825,758

(22) Filed: Jun. 29, 2010

(51) Int. Cl. H04N 7/167; H04N 7/16

(52) U.S. Cl. 725/31; 380/211; 725/139

(57) ABSTRACT

A particular method of user-defined modification of video content includes receiving video content at a set-top box (STB) and converting the video content into modifiable video content. The method includes selecting an image in at least one frame of the modifiable video content. The image is associated with a user-defined modification condition. The at least one frame of the modifiable video content is modified to generate modified video content. Modifying the at least one frame includes modifying the selected image in the at least one frame.

### FIELD OF THE DISCLOSURE

The present disclosure is generally related to modification of video content.

### BACKGROUND

Advertising is commonplace in television. In the traditional television advertising model, sets of advertising clips (e.g., videos that are 30 or 60 seconds in length) are interspersed into television programs. However, traditional television advertising methodologies can by bypassed during time-shifting. For example, a user may record a “live” television program and may view the program later, at a time that is more convenient to the user. Many television recorders/players enable users to fast-forward the recording, thereby enabling users to selectively fast-forward past or through advertising clips interspersed in the television content.

In response to the ability to fast-forward traditional advertisements, some advertisers have started placing advertisements into television programs themselves. Users are forced to view such advertising, even during time-shifting. Although such advertising may reach a larger target audience, the encroachment of advertising into the main program viewing area may annoy television viewers.

### BRIEF DESCRIPTION OF THE DRAWINGS

FIG. 1 is a diagram to illustrate a particular embodiment of a system to perform user-defined modification of video content;

FIG. 2 is a diagram to illustrate a particular embodiment of the user-defined modification conditions and images of FIG. 1;

FIG. 3 is a flow diagram to illustrate a particular embodiment of a method to perform user-defined modification of video content;

FIG. 4 is a flow diagram to illustrate another particular embodiment of a method to perform user-defined modification of video content;

FIG. 5 is a diagram to illustrate a particular embodiment of user-defined static advertising obfuscation in video content;

FIG. 6 is a diagram to illustrate a particular embodiment of user-defined dynamic advertising obfuscation in video content;

FIG. 7 is a diagram to illustrate a particular embodiment of user-defined accessibility modification in video content; and

FIG. 8 is a block diagram of an illustrative embodiment of a general computer system operable to support embodiments of computer-implemented methods, computer program products, and system components as illustrated in FIGS. 1-7.

### DETAILED DESCRIPTION

Television (TV) content is typically transmitted to users as an unmodifiable (e.g., encrypted and read-only) data stream. If a user does not like what is on TV (e.g., due to the encroachment of advertising into a television program), the user may have no choice other than to endure the advertising or to change the channel. The present disclosure describes user-defined modifications of live and recorded video content. The received video content may be converted into modifiable video content (e.g., by decrypting and write-enabling the received video content). The user may edit the modifiable video content as desired. For example, images in the modifiable video content may be removed, obfuscated, edited, or replaced. In particular implementations, a database including user-defined modification conditions may be used to automatically modify video content. The resulting modified video content may be stored or transmitted for display to a display device. The systems and methods of the present disclosure may thus enable users to modify TV content as desired, thereby resulting in a more enjoyable television viewing experience. Furthermore, user-defined modifications of video content (e.g., TV content) may be performed on a real-time, near real-time, or delayed basis with respect to “live” video content as well as time-shifted video content.

In a particular embodiment, a method includes receiving video content at a set-top box (STB). The method also includes converting the video content into modifiable video content. The method further includes selecting an image in at least one frame of the modifiable video content, where the image is associated with a user-defined modification condition stored at the STB. The method includes modifying the at least one frame of the modifiable video content to generate modified video content, where modifying the at least one frame includes modifying the selected image in the at least one frame.

In another particular embodiment, a system includes an input interface configured to receive Internet protocol television (IPTV) video content. The system also includes a conversion module configured to convert the received IPTV video content into modifiable video content. The system further includes a database configured to store a plurality of images. The system includes a modification module configured to detect that a particular image stored at the database is included in at least one frame of the modifiable video content. The modification module is also configured to modify the at least one frame of the modifiable video content in accordance with a user-defined modification action associated with the particular image to generate modified video content. Modifying the at least one frame includes modifying the particular image in the at least one frame. The system also includes an output interface configured to transmit the modified video content for display.

In another particular embodiment, a processor-readable medium includes instructions, that when executed by a processor, cause the processor to receive video content at a set-top box (STB). The instructions also cause the processor to convert the video content into modifiable video content. The instructions further cause the processor to select an image in at least one frame of the modifiable video content, where the image is associated with a user-defined modification condition stored at the STB. The instructions cause the processor to modify the at least one frame of the modifiable video content to generate modified video content, where modifying the at least one frame includes modifying the selected image in the at least one frame. The instructions also cause the processor to transmit the modified video content for display.

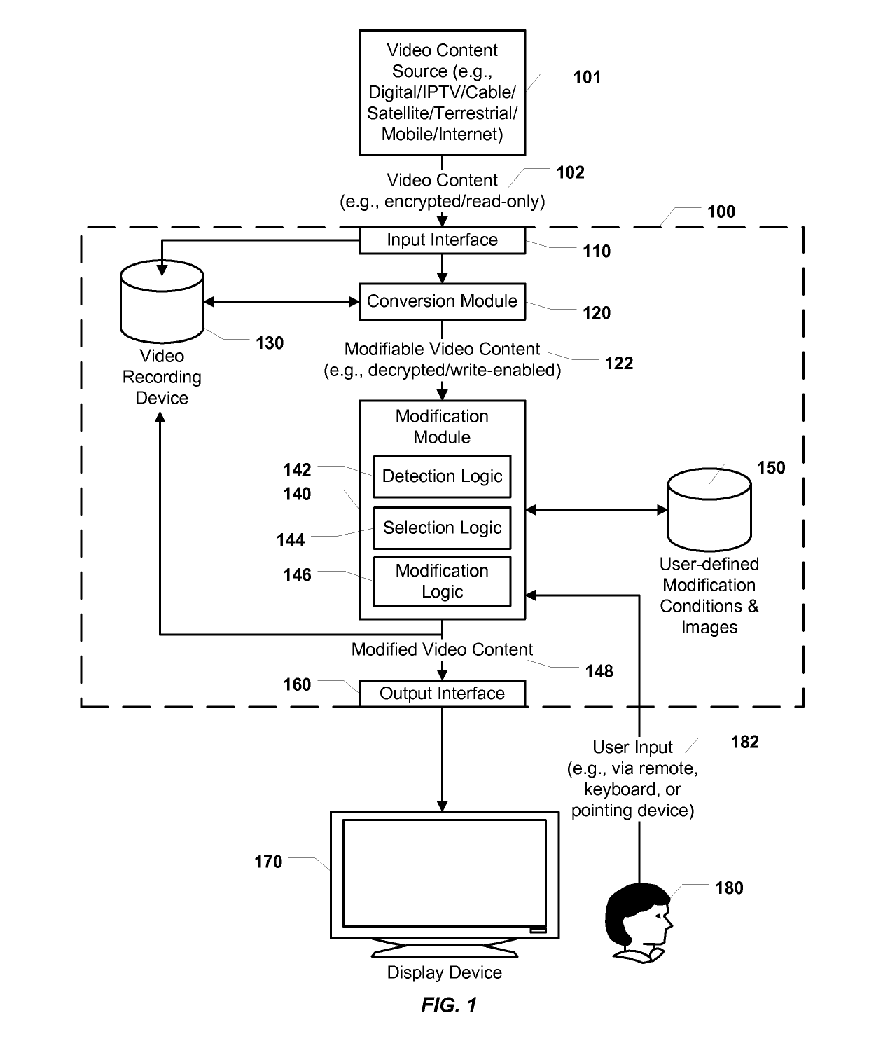

Referring to FIG. 1, a particular embodiment of a system 100 to perform user-defined modification of video content is illustrated. The system 100 may receive video content 102 from a video content source 101 and may transmit content for display to a display device 170 (e.g., a television).

The system 100 includes an input interface 110 configured to receive the video content 102 from the video content source 101. In a particular embodiment, the video content source 101 is a digital source, an IPTV source (e.g., configured to deliver TV content via a proprietary/private network), a cable TV source, a satellite TV source, a terrestrial TV content (e.g., “over the air” TV) source, a mobile TV content source, an Internet TV content source (e.g., configured to deliver TV content via the public Internet), or any combination thereof. The video content 102 may be unmodifiable video content. For example, the video content 102 may be in a proprietary content format that is encrypted and read-only. The input interface 110 may be a wired interface, such as an Ethernet interface, a coaxial interface, or a universal serial bus (USB) interface. Alternatively, the input interface 110 may be a wireless interface such as an IEEE 802.11 wireless interface. In a particular embodiment, the input interface 110 receives the video content 102 from the video content source 101 via one or more intermediate customer premises equipment (CPE) devices (not shown), such as a residential gateway, router, cable modem, satellite dish, or antenna.

The system 100 also includes a conversion module 120 configured to convert the video content 102 received at the input interface 110 into modifiable video content 122. For example, the conversion module 120 may convert “live” video content in real-time or near real-time as the “live” video content is received at the input interface 110. Alternately, the conversion module 120 may convert video content retrieved from a video recording device 130 (e.g., a digital video recorder (DVR) or personal video recorder (PVR) device). In a particular embodiment, converting the video content 102 into the modifiable video content 122 includes performing decryption and write-enabling operations. The video content 102 and the modifiable video content 122 may be represented by a common video format (e.g., Motion Picture Experts Group (MPEG)) or by different video formats.

The system 100 further includes a modification module 140 and a database 150 of user-defined modification conditions and images. The modification module 140 may include detection logic 142 configured to automatically detect that a particular image stored at the database 150 is included in at least one frame of the modifiable video content 122. The modification module 140 may also include modification logic 146 configured to modify the at least one frame in accordance with a user-defined modification condition stored at the database 150, thereby generating modified video content 148. For example, the database 150 may include a particular advertising logo. The detection logic 142 may detect that the particular advertising logo is present in at least one frame of the modifiable video content and the modification logic 146 may remove or obfuscate (e.g., by blurring or blending into the background) the advertising logo in the at least one frame.

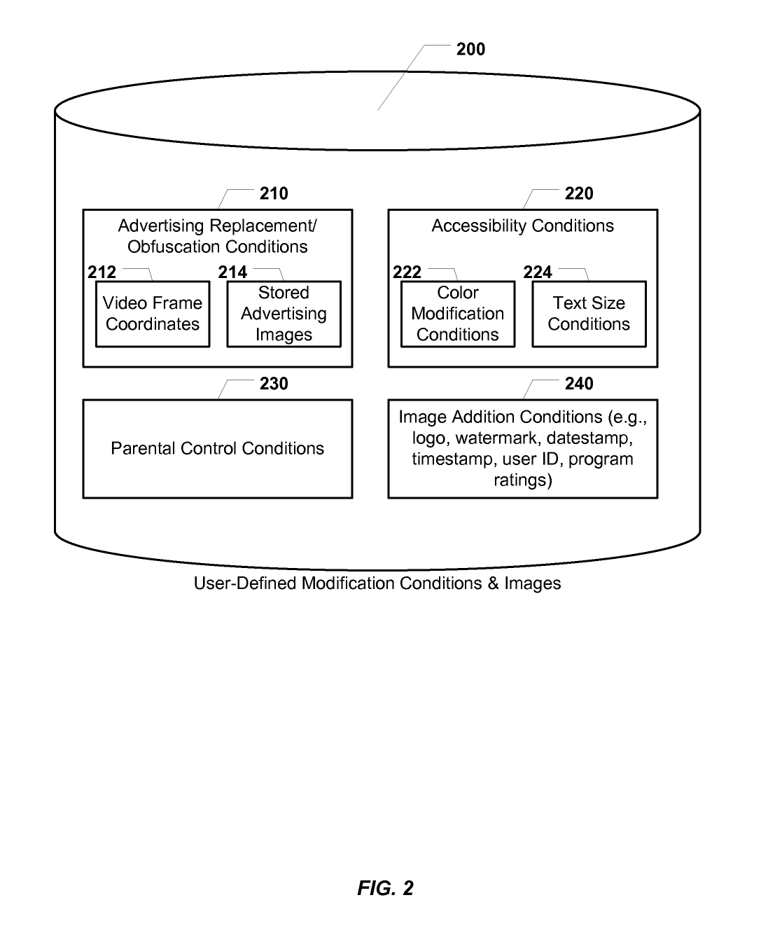

The modification module 140 may perform additional operations besides user-defined removal and obfuscation of advertising. For example, the modification module 140 may also modify a color, shape, contrast, brightness, shape, or location of an image. The modification module 140 may also replace a selected image (e.g., a face) with a second image (e.g., a different face). For example, the modification module 140 may automatically perform a “find and replace” operation with respect to a particular actor's face, actress's face, or animated/virtual character's face (e.g., in a virtual universe setting). The modification module 140 may detect violations of parental control conditions and may modify the modifiable video content 122 to comply with the parental control conditions. In a particular embodiment, the modification module 140 may also be configured to add images (e.g., user-defined logos or watermarks) to the modifiable video content 122. Additional examples of user-defined modification conditions and images are further illustrated and described with reference to FIGS. 2 and 5-7.

In a particular embodiment, the modification module 140 may also modify manually selected images in the modifiable video content. For example, the modification module 140 may include selection logic 144 configured to select a particular image in a particular frame of the modifiable video content 122. The particular image may be selected via user input 182 received from a user 180 (e.g., via a remote, keyboard, or pointing device). The selected particular image may be stored at the database 150. For example, the user 180 may provide user input 182 indicating a manual selection of an advertising logo in the modifiable video content 122. The user input 182 may further indicate that the advertising logo should be obfuscated in the modified video content 148. The selected advertising logo may be stored in the database 150, so that the advertising logo is automatically detected and obfuscated by the modification module 140 each time the advertising logo is subsequently encountered. The database 150 may store separate user-defined modification conditions and images for each episode of a TV program, for all episodes of a TV program, or for all TV programs airing on a particular TV channel, etc. The database 150 may also store “universal” user-defined modification conditions and images applicable to all video content received at the system 100.

The modified video content 148 generated by the modification module 140 may be stored at the video recording device 130 (e.g., enabling “offline” modification of DVR content) or may be transmitted for display via an output interface 160. For example, the output interface 160 may transmit the modified video content 148 for display to the display device 170 (e.g., a television). In a particular embodiment, the output interface is an analog or digital audio/video interface. For example, the output interface may be a high-definition multimedia interface (HDMI).

It should be noted that the video recording device 130 and the database 150 may be implemented using a common data storage device or separate data storage devices. It should also be noted that the various components of the system 100 may be incorporated into a single standalone device (e.g., a set-top box) or may be part of an integrated system (e.g., integrated into a television system or a mobile video device such as a personal television player or a mobile phone). Alternately, components of the system 10 may be located remote to each other. For example, the database 150 may be an external database that is remote to the modification module 140.

In operation, the input interface 110 may receive the video content 102 from the video content source 101. For example, the video content may be encrypted, read-only, and/or proprietary format content received via a digital, IPTV, cable, satellite, and/or terrestrial source. The received video content 102 may optionally be stored at the video recording device 130 (e.g., DVR). The conversion module 120 may convert the received video content 102 into the modifiable video content 122. For example, the modifiable video content 122 may be decrypted, write-enabled, and non-proprietary format content. The modification module 140 may automatically detect and modify one or more images in one or more frames of the modifiable video content 122 based on the user-defined modification conditions and images stored in the database 150. The modification module 140 may also select particular images in frames of the modifiable video content 122 for modification based on the user input 182 received from the user 180. The resulting modified video content 148 may be stored to the video recording device 130. The modified video content 148 may also be transmitted to the display device 170 via the output interface 160.

It will be appreciated that the system 100 of FIG. 1 may convert unmodifiable video content (e.g., television content) into modifiable video content and may enable user-defined removal, modification, and addition of images in the modifiable video content. Whereas content provider-defined modifications (e.g., the insertion of advertising) may lead to user annoyance, it will be appreciated that the user-defined modifications enabled by the system 100 of FIG. 1 may provide users with a more enjoyable video content viewing experience. It will also be appreciated that in a particular embodiment, a video content provider may leverage the functionality disclosed herein for revenue generation. For example, a television provider may charge subscribers a one-time fee to download software representing the conversion module 120 and/or the modification module 140. The television provider may also, or alternately, charge subscribers a use fee for using the conversion module 120 and/or the modification module 140. For example, the fee may be a periodic fee, a fee dependent on a number of video content items modified, a free dependent on a length of video content items modified, or any combination thereof.

Referring to FIG. 2, a particular embodiment of a database 200 of user-defined modification conditions and images is illustrated. In an illustrative embodiment, the database 200 is the database 150 of FIG. 1.

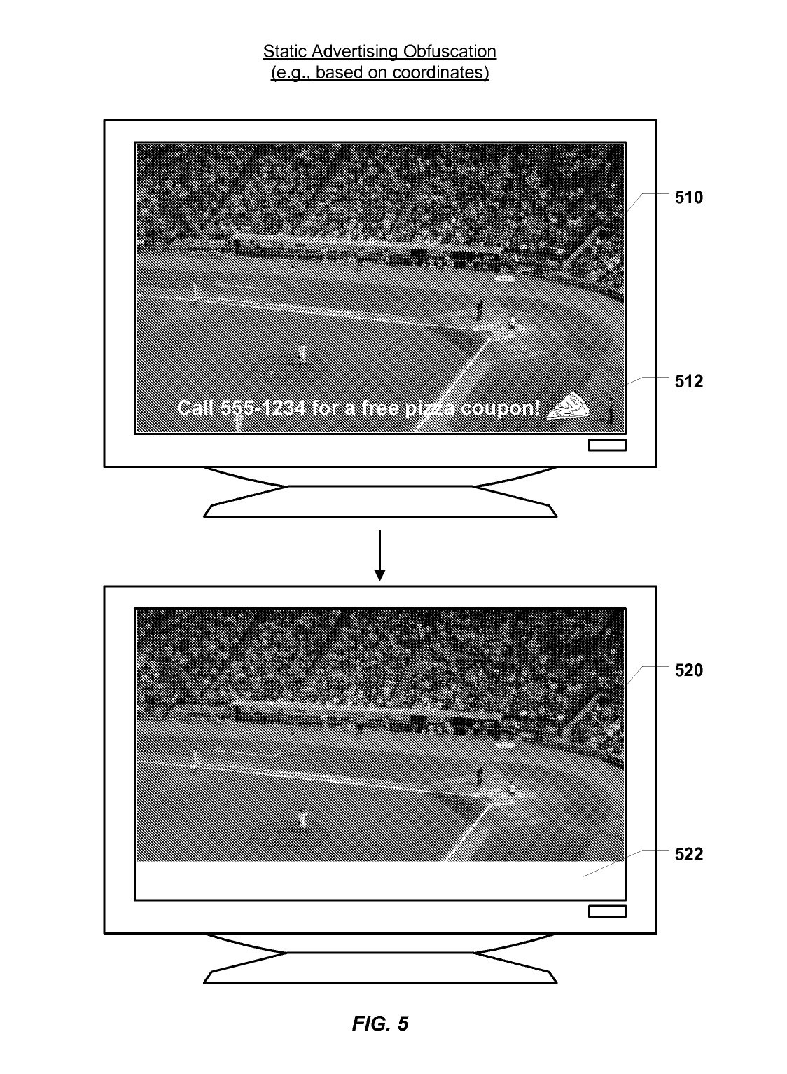

The database 200 may include advertising replacement and obfuscation conditions 210. For example, advertising replacement and obfuscation may be static or dynamic, depending on whether the advertisement is static or dynamic. Static advertisements may appear in frames of video content at particular video coordinates. For example, a static banner advertisement may occasionally appear in the lower one-eighth of a television program. The advertising replacement and obfuscation conditions 210 may include video frame coordinates 212 where static advertisements appear. Static advertisement obfuscation is further illustrated and described with reference to FIG. 5.

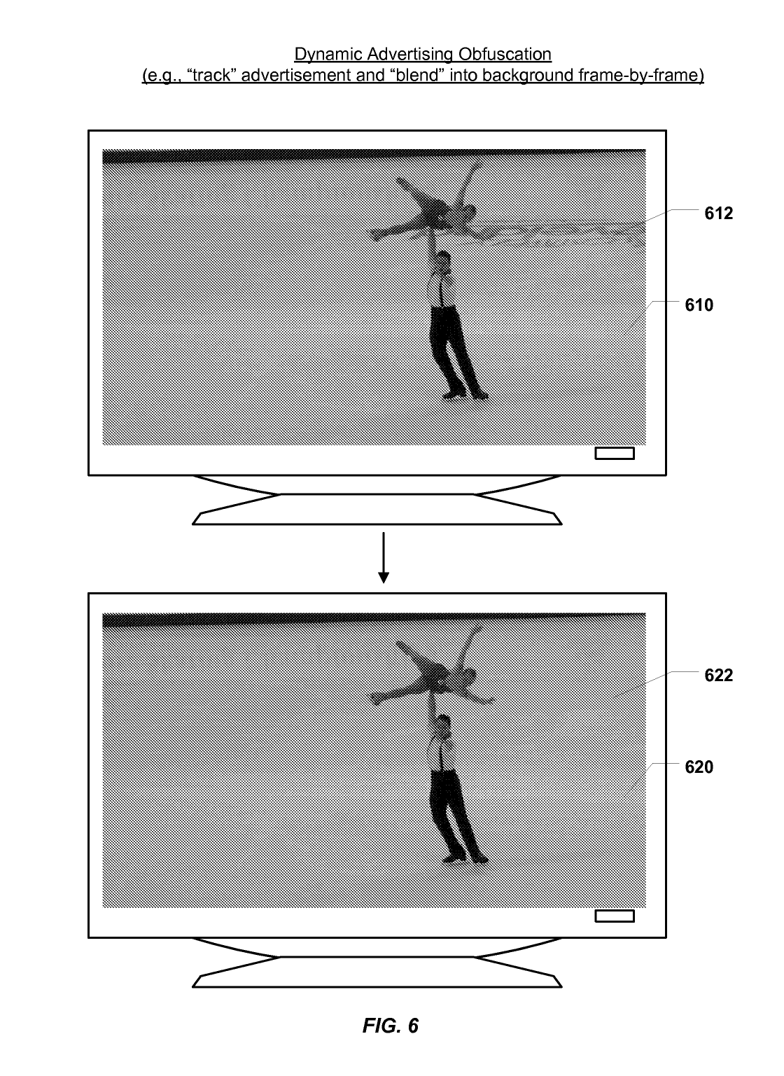

In contrast to static advertisements, dynamic advertisements may appear at any coordinates of a video frame. For example, a dynamic advertisement may appear on an advertising board on the periphery of a soccer field. As a television camera pans and zooms, the coordinates of the dynamic advertisement may change within video content frames. The advertising replacement and obfuscation conditions 210 may include stored advertising images 214 corresponding to dynamic advertisements. For example, the stored advertising images 214 may include the image depicted in the advertising board on the periphery of the soccer field. The dynamic advertisement may be “tracked” and removed/obfuscated based on a comparison of each video frame with the stored advertising images 214. For example, the dynamic advertisement may be blurred or may be blended into the background of each video content frame. The stored advertising images 214 may be downloaded from third-party databases or may be user-defined (e.g., via manual image selection). Dynamic advertising obfuscation is further illustrated and described with reference to FIG. 6.

It will be appreciated that image removal/obfuscation methodologies described with respect to advertising may also be extended to non-advertising images. For example, any image within video content may be dynamically tracked and modified. As another example, a sports television channel may constantly display a “ticker” with updated sports scores. If a user does not want to know the result of a particular sporting event (e.g., because the user plans on subsequently watching the sporting event in a time-shifted manner) the user may statically remove/obfuscate the ticker.

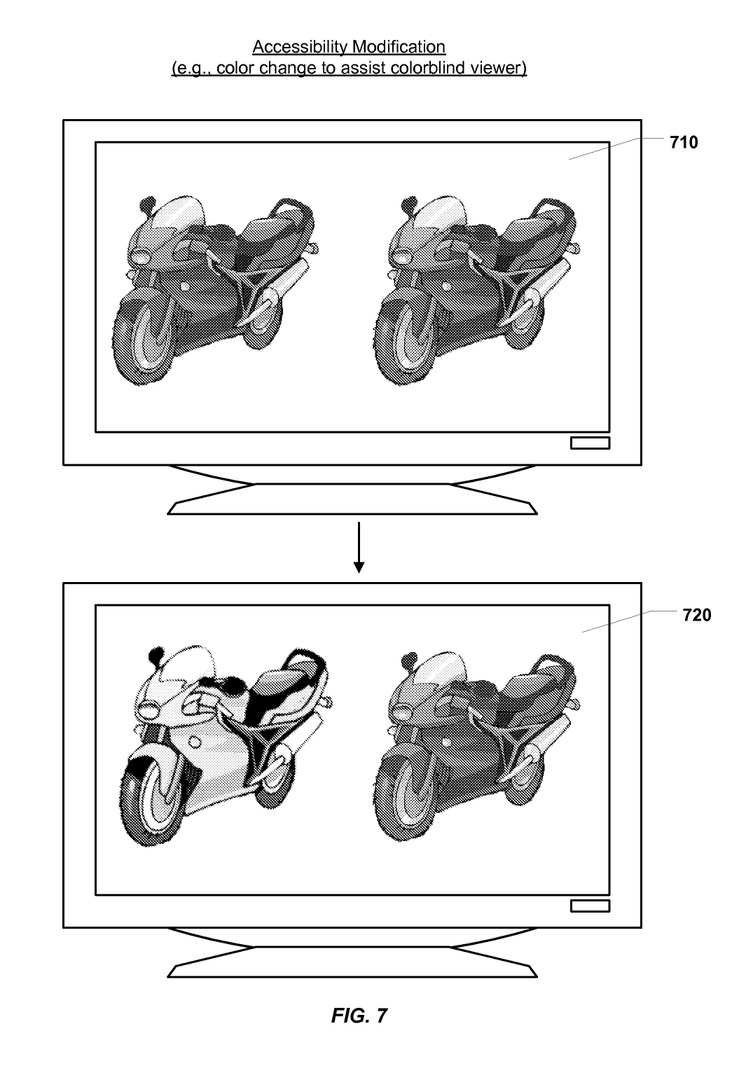

The database 200 may further include accessibility conditions 220. For example, the accessibility conditions 220 may include color modification conditions 222 and text size conditions 224. In a particular embodiment, the color modification conditions 222 may result in automatic modification of colors in video content to assist colorblind viewers (e.g., as described and illustrated with reference to FIG. 7). For example, if two teams competing in a sporting event are wearing red and green uniforms, respectively, red-green colorblind viewers may have difficulty distinguishing the teams. The color modification conditions 222 may result in altering the color or pattern of one of the team uniforms to assist the viewer. For example, the green uniforms may be changed to white uniforms and a stripe pattern may be introduced to assist the viewer. The color modification conditions 222 may also be used to enhance or subdue colors in video content to suit individual user preferences. The text size conditions 224 may indicate that particular text should be enlarged or shrunk. For example, the text size conditions 224 may indicate that all text in a video frame that is smaller than a particular text size threshold should be enlarged to meet the threshold.

The database 200 may further include parental control conditions 230 and image addition conditions 240. The parental control conditions 230 may identify content to be removed, obfuscated, or replaced before being viewed. For example, although a particular objectionable word is not spoken during a television program, the particular objectionable word may visually appear in the television program as text on a character's t-shirt. The parental control conditions 230 may result in the automatic removal, blurring, or replacement of text on the character's t-shirt. The image addition conditions 240 may result in the automatic addition of particular images to frames of video content. In a particular embodiment, the added images include one or more of user-defined logos, user-defined watermarks, datestamps, timestamps, user identifiers (IDs), and program ratings. For example, a TV program may include a particular program rating (e.g., parental guideline) of “TV-PG.” A “TV-PG” rating may be displayed at the start of the TV program but not thereafter. The image addition conditions 240 may “persist” the “TV-PG” program rating by causing the addition of the “TV-PG” icon to each frame of the TV program, so that a user may determine the program rating of the program from any frame of the program. In another illustrative embodiment, the image addition conditions 240 may add personalized logos, watermarks, or notations to video content for use in subsequent cataloguing.

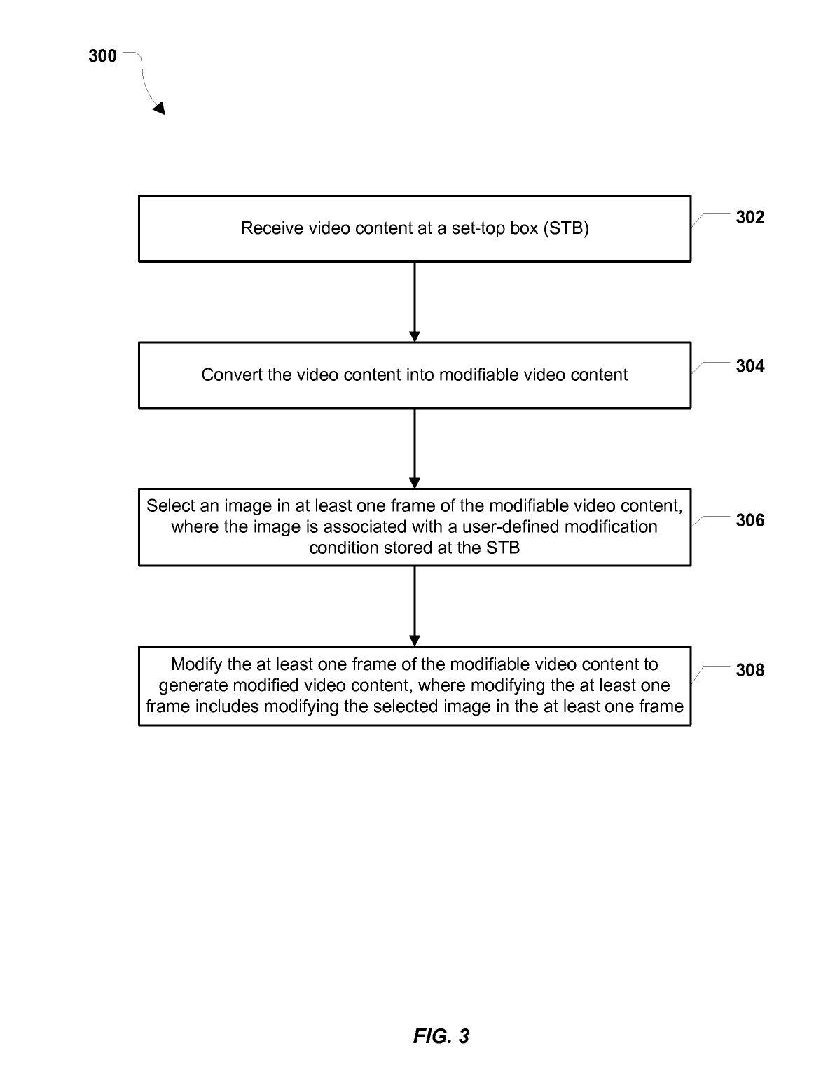

Referring to FIG. 3, a flow diagram of a particular embodiment of a method 300 to perform user-defined modification of video content is illustrated. In an illustrative embodiment, the method 300 may be performed at the system 100 of FIG. 1.

The method 300 includes receiving video content at a set-top box (STB), at 302. For example, in FIG. 1, the input interface 110 may receive the video content 102. The method 300 also includes converting the video content into modifiable video content, at 304. For example, in FIG. 1, the conversion module 120 may convert the video content 102 into the modifiable video content 122.

The method 300 further includes selecting an image in at least one frame of the modifiable video content, at 306. The image is associated with a user-defined modification condition stored at the STB. For example, in FIG. 1, the modification module 140 may select an image in at least one frame of the modifiable video content 122 based on a user-defined modification condition stored at the database 150.

The method 300 includes modifying the at least one frame of the modifiable video content to generate modified video content, at 308. Modifying the at least one frame includes modifying the selected image in the at least one frame. For example, the modification module 140 may modify the selected image in at least one frame of the modifiable video content 122 to generate the modified video content 148.

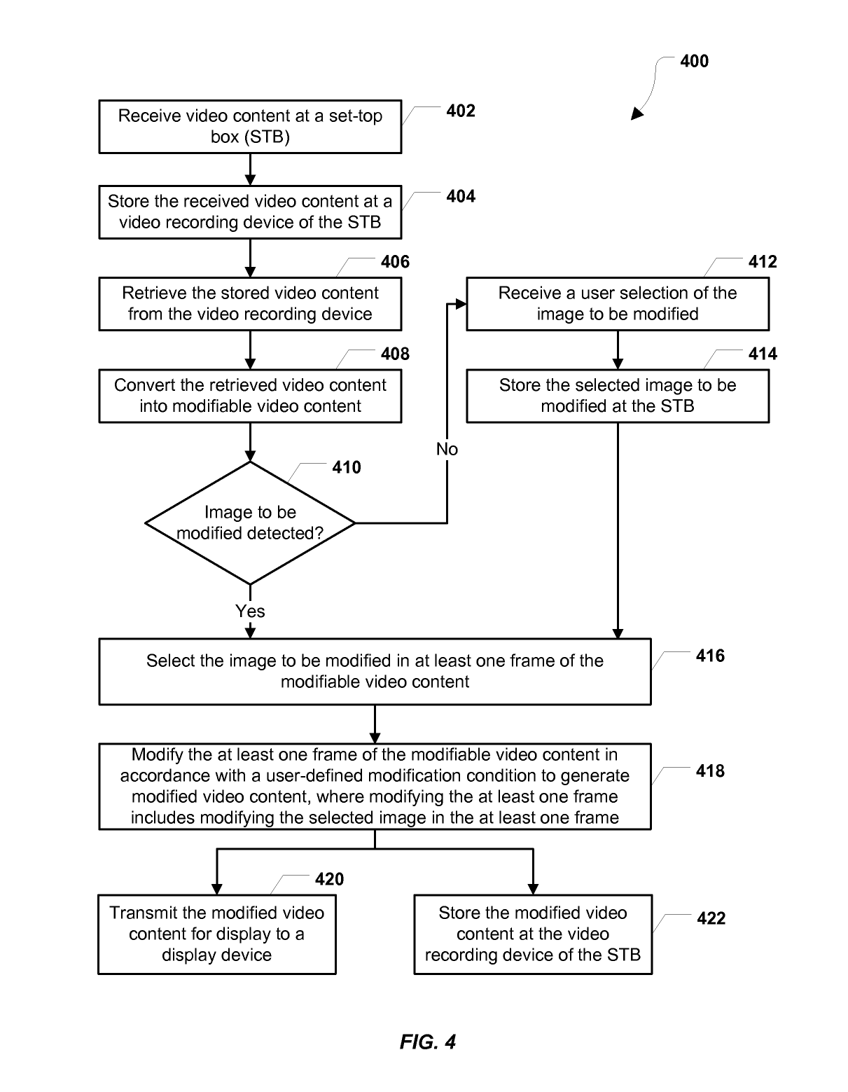

Referring to FIG. 4, a flow diagram of another particular embodiment of a method 400 to perform user-defined modification of video content is illustrated. In an illustrative embodiment, the method 400 may be performed at the system 100 of FIG. 1.

The method 400 includes receiving video content at a set-top box (STB), at 402, and storing the received video content at a video recording device of the STB, at 404. For example, in FIG. 1, the input interface 110 may receive the video content 102 and may store the video content 102 at the video recording device 130.

The method 400 also includes retrieving the stored video content from the video recording device, at 406, and converting the retrieved video content into modifiable video content, at 408. For example, in FIG. 1, the conversion module 120 may retrieve the video content 102 from the video recording device 130 and may convert the video content 102 into the modifiable video content 122.

The method 400 further includes determining whether an image to be modified is detected, at 410. When the image to be modified is not detected, the method 400 includes receiving a user selection of the image to be modified, at 412, and storing the selected image to be modified at the STB, at 414. For example, in FIG. 1, the modification module 140 may determine that the frames of the modifiable video content 122 do not match any of the user-defined modification conditions or images stored at the database 150. The modification module 140 may receive a user selection of an image to be modified (e.g., via the user input 182 from the user 180) and may store the image at the database 150. In a particular embodiment, the modification module 140 provides an interface (e.g., at the display device 170) enabling the user 180 to rewind, fast-forward, and pause frames of the modifiable video content 148 to select the image.

When the image to be modified is detected, or after the image to be modified is stored at the STB at 414, the method 400 includes selecting the image to be modified in at least one frame of the modifiable video content, at 416. The method 400 also includes modifying the at least one frame of the modifiable video content in accordance with a user-defined modification condition to generate modified video content, at 418. For example, in FIG. 1, the modification module 140 may modify the modifiable video content 122 in accordance with a user-defined modification condition stored at the database 150 to generate the modified video content 148. In a particular embodiment, modifying the modifiable video content 122 includes modifying, removing, adding, and/or replacing images in frames of the modifiable video content 122.

The method 400 further includes transmitting the modified content for display to a display device at 420. For example, in FIG. 1, the modified video content 148 may be transmitted to the display device 170 via the output interface 160. Alternately, the method 400 includes storing the modified video content at the video recording device of the STB, at 422. For example, in FIG. 1, the modified video content 148 may be stored at the video recording device 130.

It will be appreciated that the method 400 of FIG. 4 may enable automatic user-defined modification of video content as well as manual (e.g., via user selection) modification of video content, thereby providing users with a more enjoyable video content viewing experience. It will also be appreciated that the method 400 of FIG. 4 may enable user-defined modification of video content that has previously been stored at a video recording device, thereby providing users with an ability to edit DVR content as desired prior to viewing the DVR content.

Referring to FIG. 5, a particular embodiment of user-defined static advertising obfuscation in video content is illustrated. In an illustrative embodiment, the user-defined static advertising obfuscation may be performed by the modification module 140 of FIG. 1.

A static advertisement may appear in one or more frames of video content at particular pre-defined coordinates. That is, static advertisements may not “move” while they are displayed. In a particular embodiment, static advertising obfuscation is performed by “covering” a static advertisement based on the coordinates of the static advertisement.

For example, a frame 510 of video content may include a static advertisement 512 for a pizza coupon. The static advertisement 510 may be detected based on a stored advertising replacement and obfuscation condition (e.g., the advertising replacement and obfuscation conditions 210 of FIG. 2). In a particular embodiment, video frame coordinates where static advertising has previously appeared (or is expected to appear) during a baseball telecast may be stored (e.g., as the video frame coordinates 212 of FIG. 2). Based on the video frame coordinates, the static advertisement 512 may be “covered” by a covering image 522, as illustrated by the frame 520. The covering image 522 may be any shape, size, and color/pattern. In a particular embodiment, the covering image 522 is generated based on other images and colors in the frame 520 or based on video content in other frames of the baseball telecast. For example, the covering image 522 may be generated to approximate what the frame 520 would look like if the static advertisement 512 was not displayed, thereby resulting in advertising obfuscation that is invisible or near-invisible to a user.

Referring to FIG. 6, a particular embodiment of user-defined dynamic advertising obfuscation in video content is illustrated. In an illustrative embodiment, the user-defined dynamic advertising obfuscation may be performed by the modification module 140 of FIG. 1.

Dynamic advertisements may change coordinates (e.g., “move”) from frame to frame of video content. In a particular embodiment, dynamic advertisement obfuscation includes detecting a match between the dynamic advertisement and a stored advertising image (e.g., one of the stored advertising images 214 of FIG. 2) and “tracking” the dynamic advertisement from frame to frame. As the dynamic advertisement is “tracked,” the dynamic advertisement may be obfuscated in each frame.

For example, a frame 610 of video content representing a skating performance may include a dynamic advertisement 612 that will “move” as the camera pans and zooms around the skating rink. The dynamic advertisement 612 may be obfuscated in each such frame. For example, the dynamic advertisement may be “blended” into the background (in this case, the ice), as illustrated by the “blended” advertisement 622 in the frame 620. In a particular embodiment, the “blended” advertisement 522 is invisible or near-invisible to a user.

Referring to FIG. 7, a particular embodiment of user-defined accessibility modification in video content is illustrated. In an illustrative embodiment, the user-defined accessibility modification may be performed by the modification module 140 of FIG. 1.

As an illustrative and non-limiting example, consider a user that is colorblind. The user may have specified and stored a color modification condition (e.g., one of the color modification conditions 222 of FIG. 2) that indicates his or her inability to distinguish between certain colors. Based on the stored color modification condition, the color and pattern of an image in video content may be modified to assist the user in distinguishing the image from other images.

For example, the user may enjoy viewing motorcycle race telecasts. During a particular race, two motorcycles in a frame 710 of video content may be difficult for the user to distinguish. Based on the stored color modification condition, the color of one of the motorcycles may be modified, as illustrated in the frame 720, thereby enabling the user to distinguish between the two motorcycles and enjoy the race telecast.

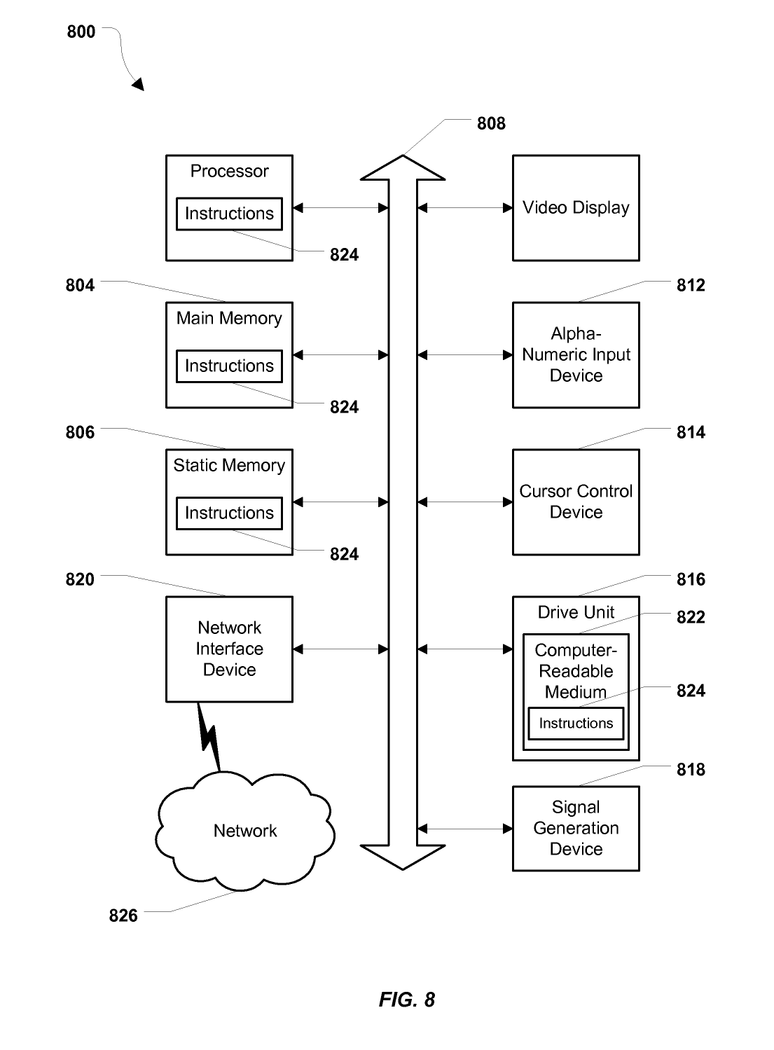

Referring to FIG. 8, an illustrative embodiment of a general computer system is shown and is designated 800. For example, the computer system 800 may include, implement, or be implemented by one or more components of the system 100 of FIG. 1 and the database 200 of FIG. 2. The computer system 800 includes a set of instructions that can be executed to cause the computer system 800 to perform any one or more of the methods or computer based functions disclosed herein. The computer system 800, or any portion thereof, may operate as a standalone device or may be connected, e.g., using a network, to other computer systems or peripheral devices.

In a networked deployment, the computer system 800 may operate in the capacity of a set-top box device, a personal computing device, a mobile computing device, or some other computing device. The computer system 800 can also be implemented as or incorporated into various devices, such as a personal computer (PC), a tablet PC, a personal digital assistant (PDA), a mobile device, a palmtop computer, a laptop computer, a desktop computer, a communications device, a web appliance, a television or other display device, or any other machine capable of executing a set of instructions (sequential or otherwise) that specify actions to be taken by that machine. In a particular embodiment, the computer system 800 can be implemented using electronic devices that provide voice, video, or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics-processing unit (GPU), or both. Moreover, the computer system 800 can include a main memory 804 and a static memory 806 that can communicate with each other via a bus 808. As shown, the computer system 800 may further include or be coupled to a video display unit 810, such as a liquid crystal display (LCD), an organic light emitting diode (OLED), a flat panel display, a solid-state display, or a projection display. For example, the video display unit 810 may be the display device 170 of FIG. 1. Additionally, the computer system 800 may include an input device 812, such as a keyboard, a remote control device, and a cursor control device 814, such as a mouse. In a particular embodiment, the cursor control device 814 may be incorporated into a remote control device such as a television or set-top box remote control device. The computer system 800 can also include a disk drive unit 816, a signal generation device 818, such as a speaker or remote control device, and a network interface device 820. The network interface device 820 may be coupled to other devices (not shown) via a network 826.

In a particular embodiment, as depicted in FIG. 8, the disk drive unit 816 may include a computer-readable non-transitory medium 822 in which one or more sets of instructions 824, e.g. software, can be embedded. For example, the instructions 824 may be executable to cause execution of one or more of the conversion module 120 of FIG. 1 and the modification module 140 of FIG. 1. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable non-transitory media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/item distributed processing, and parallel processing. Alternatively, virtual computer system processing can be constructed to implement one or more of the methods or functionality as described herein.

The present disclosure contemplates a computer-readable non-transitory medium that includes instructions 824 so that a device connected to a network 826 can communicate voice, video, or data over the network 826. Further, the instructions 824 may be transmitted or received over the network 826 via the network interface device 820.

While the computer-readable non-transitory medium is shown to be a single medium, the term “computer-readable medium” includes a single medium or multiple media, such as a centralized or distributed database, and/or associated caches and servers that store one or more sets of instructions. The term “computer-readable non-transitory medium” shall also include any medium that is capable of storing a set of instructions for execution by a processor or that cause a computer system to perform any one or more of the methods or operations disclosed herein.

In a particular non-limiting, exemplary embodiment, the computer-readable non-transitory medium can include a solid-state memory such as a memory card or other package that houses one or more non-volatile read-only memories. Further, the computer-readable non-transitory medium can be a random access memory or other volatile re-writable memory. Additionally, the computer-readable non-transitory medium can include a magneto-optical or optical medium, such as a disk or tapes. Accordingly, the disclosure is considered to include any one or more of a computer-readable non-transitory storage medium and successor media, in which data or instructions may be stored.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories.

Although the present specification describes components and functions that may be implemented in particular embodiments with reference to particular standards and protocols, the invention is not limited to such standards and protocols. For example, standards for Internet, other packet switched network transmission (e.g. TCP/IP, UDP/IP, HTML, X10, SIP, TR-069, INSTEON, WEP, Wi-Fi and HTTP) and standards for viewing media content (e.g. MPEG and H.264) represent examples of the state of the art. Such standards are periodically superseded by faster or more efficient equivalents having essentially the same functions. Accordingly, replacement standards and protocols having the same or similar functions as those disclosed herein are considered equivalents thereof.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method, comprising:
receiving video content at a set-top box (STB);
converting the video content into modifiable video content;
selecting an image in at least one frame of the modifiable video content, wherein the image is associated with a user-defined modification condition; and
modifying the at least one frame of the modifiable video content to generate modified video content, wherein modifying the at least one frame includes modifying the selected image in the at least one frame.

2. The method of claim 1, wherein the user-defined modification condition is stored at the STB and wherein the received video content comprises digital video content, Internet protocol television (IPTV) content, cable TV content, satellite TV content, over-the-air TV content, mobile TV content, Internet TV content, or any combination thereof.

3. The method of claim 1, further comprising one or more of transmitting the modified video content for display to a display device and storing the modified video content at the STB.

4. The method of claim 1, wherein the video content comprises at least one of encrypted content and read-only content and wherein the modifiable video content comprises at least one of decrypted content and write-enabled content.

5. The method of claim 1, wherein modifying the selected image comprises removing the selected image from the at least one frame, obfuscating the selected image, modifying a color of the selected image, modifying a shape of the selected image, modifying a contrast of the selected image, modifying a brightness of the selected image, modifying a size of the selected image, modifying a location of the selected image in the at least one frame, or any combination thereof.

6. The method of claim 1, wherein modifying the selected image comprises replacing the selected image with a second image.

7. The method of claim 6, wherein the selected image is a face and wherein the second image is a different face.

8. The method of claim 1, wherein the user-defined modification condition includes a parental control condition and wherein the selected image violates the parental control condition.

9. The method of claim 1, wherein the user-defined modification condition includes an advertising removal condition or an advertising obfuscation condition and wherein the selected image is an advertising image.

10. The method of claim 1, wherein the user-defined modification condition includes an accessibility condition.

11. The method of claim 1, further comprising adding a particular image to one or more frames of the modifiable video content, wherein the added particular image comprises a logo, a watermark, a datestamp, a timestamp, user identification information, program ratings information, or any combination thereof.

12. The method of claim 1, wherein the selected image is selected based on user input received at the STB via a remote control device, a keyboard, a pointing device, or any combination thereof.

13. The method of claim 1, further comprising storing the selected image at a storage device of the STB.

14. The method of claim 13, further comprising:
searching the modifiable video content for any of a plurality of images stored at the storage device of the STB; and
when a particular image of the plurality of images is found in the modifiable video content, modifying the particular image in the modifiable video content.

15. The method of claim 1, further comprising storing the received video content at a video recording device of the STB, wherein converting the video content into the modifiable video content comprises retrieving the stored video content from the video recording device and converting the stored video content into the modifiable video content.

16. The method of claim 1, wherein the STB is integrated into a television device.

17. A system, comprising:
an input interface configured to receive Internet protocol television (IPTV) video content;
a conversion module configured to convert the received IPTV video content into modifiable video content;
a database configured to store a plurality of images;
a modification module configured to:
detect that a particular image stored at the database is included in at least one frame of the modifiable video content; and
modify the at least one frame of the modifiable video content in accordance with a user-defined modification action associated with the particular image to generate modified video content, wherein modifying the at least one frame includes modifying the particular image in the at least one frame; and
an output interface configured to transmit the modified video content for display.

18. The system of claim 17, wherein the user-defined modification action includes removing the particular image from the at least one frame, obfuscating the particular image in the at least one frame, replacing the particular image in the at least one frame with a second image, or any combination thereof.

19. A processor-readable medium comprising instructions that when executed by a processor, cause the processor to:
receive video content at a set-top box (STB);
convert the video content into modifiable video content;
select an image in at least one frame of the modifiable video content, wherein the image is associated with a user-defined modification condition;
modify the at least one frame of the modifiable video content to generate modified video content, wherein modifying the at least one frame includes modifying the selected image in the at least one frame; and
transmit the modified video content for display.

20. The processor-readable medium of claim 19, wherein the modified video content is generated in real-time or near real-time with respect to receiving the video content at the STB.
